(19) United States
(12) Patent Application Publication
(10) Pub. No.: US 2012/0194511 A1
(43) Pub. Date: Aug. 2, 2012

(54) APPARATUS AND METHOD FOR PROVIDING 3D INPUT INTERFACE

(75) Inventor: Jae-Woo CHO, Seoul (KR)

(73) Assignee: PANTECH CO., LTD., Seoul (KR)

(21) Appl. No.: 13/347,359

(22) Filed: Jan. 10, 2012

(30) Foreign Application Priority Data
Jan. 31, 2011 (KR) 10-2011-0009629

(51) Int. Cl. G06F 3/042

(52) U.S. Cl. 345/419

(57) ABSTRACT

An apparatus and method for providing a three-dimensional (3D) input interface is provided. The apparatus includes multiple light emitters to emit an optical signal having a determined characteristic to form a 3D input recognition space; a light receiver to receive the optical signal reflected from an object, which is located in the 3D input recognition space, and to obtain luminous energy information of the optical signal; and a control unit to extract a coordinate of the object based on the luminous energy information, and to control an operation of the apparatus based on the coordinate of the object.

### CROSS-REFERENCE TO RELATED APPLICATION(S)

This application claims priority from and the benefit under 35 U.S.C. §119(a) of Korean Patent Application No. 10-2011-0009629, filed on Jan. 31, 2011, which is incorporated by reference for all purposes as if fully set forth herein.

### BACKGROUND

1. Field

The following description relates to an apparatus and method for providing a three-dimensional input interface.

2. Discussion of the Background

Touch screens and conventional key input devices have been widely used in mobile devices. Since a touch screen may replace a key input device, relatively large display screen may be provided using touch screen technology, and a mobile device may be implemented having a simpler design by eliminating the key input device. Thus, the use of touch screens in mobile devices has become widespread.

Graphical user interfaces (GUIs) in mobile devices have evolved into three-dimensional user interfaces (UIs) using a touch screen. Various three-dimensional images may be displayed as a part of the three-dimensional graphical user interfaces in mobile devices. Further, as 3D display technology develops, demands for 3D input interfaces for mobile devices to control stereoscopic 3D images may increase.

### SUMMARY

Exemplary embodiments of the present invention provide an apparatus and method for providing a three-dimensional (3D) input interface using an optical sensor. The apparatus and method provide a 3D input recognition space to receive a three-dimensional input of a user.

Additional features of the invention will be set forth in the description which follows, and in part will be apparent from the description, or may be learned by practice of the invention.

Exemplary embodiments of the present invention provide an apparatus to provide a three-dimensional (3D) input interface, including multiple light emitters to each emit an optical signal having a determined characteristic to form a 3D input recognition space; a light receiver to receive optical signal reflected from an object, which is located in the 3D input recognition space, and to obtain luminous energy information of the optical signal; and a control unit to extract a coordinate of the object based on the luminous energy information, and to control an operation of the apparatus based on the coordinate of the object.

Exemplary embodiments of the present invention provide a method for providing a three-dimensional (3D) input interface, including emitting multiple optical signals from different locations at a determined angle with respect to a surface of a display unit to generate a 3D input recognition space on the display unit; receiving optical signals reflected from an object located in the 3D input recognition space; obtaining luminous energy information from each of the optical signals reflected from the object; and extracting a coordinate of the object in the 3D input recognition space based on the luminous energy information.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an apparatus to provide a three-dimensional (3D) input interface according to an exemplary embodiment of the present invention.

FIG. 2 is a diagram illustrating an optical sensor disposed in a mobile terminal according to an exemplary embodiment of the present invention.

FIGS. 3A, 3B, and 3C are diagrams illustrating a formation of a 3D input recognition space according to an exemplary embodiment of the present invention.

FIGS. 4A and 4B are diagrams illustrating an expanded 3D input recognition space according to an exemplary embodiment of the present invention.

FIGS. 5A and 5B are diagrams illustrating an acquisition of a coordinate of an object in a 3D input recognition space according to an exemplary embodiment of the present invention.

FIG. 6 is a diagram illustrating an operation of a 3D input interface according to an exemplary embodiment of the present invention.

FIG. 7 is a flowchart illustrating a method for providing a 3D input interface according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Exemplary embodiments will now be described more fully hereinafter with reference to the accompanying drawings, in which exemplary embodiments are shown. The present disclosure may, however, be embodied in many different forms and should not be construed as limited to the exemplary embodiments set forth herein. Rather, these exemplary embodiments are provided so that the present disclosure is thorough, and will fully convey the scope of the invention to those skilled in the art.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

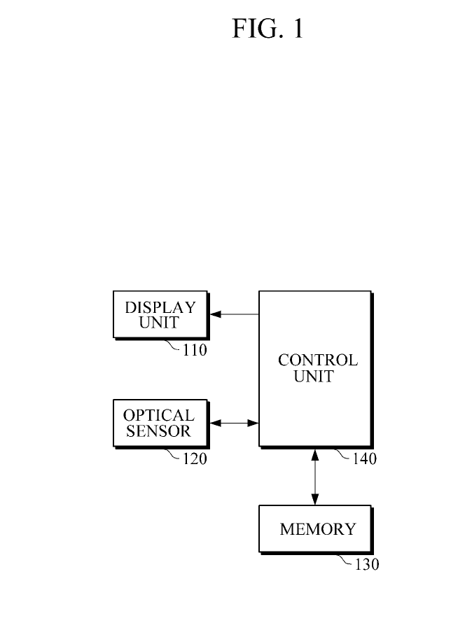

FIG. 1 is a diagram illustrating an apparatus to provide a three-dimensional (3D) input interface according to an exemplary embodiment of the present invention.

Referring to FIG. 1, the apparatus may include a display unit 110, an optical sensor 120, a memory 130, and a control unit 140. Further, the apparatus may further include at least one of an audio output unit, a vibration generation unit, and a visible light emitter (not shown). The apparatus may be a mobile communication terminal, such as a mobile phone, a smart phone, a personal digital assistant (PDA), and a navigation terminal; a personal computer, such as a desktop computer or a laptop computer; and various other devices that require an interface to receive a user input signal.

The display unit 110 may display an image, a moving picture, a graphical user interface, and the like. The display unit 110 may be a display panel, such as a liquid crystal display (LCD), a light-emitting diode (LED), and the like. The display unit 110 may display images or text in a three-dimensional form. The display unit 110 may display information processed in the apparatus, and display a user interface (UI) or a graphical user interface (GUI) in connection with various control operations. The display unit 110 may be used as a manipulation unit if the display unit 110 forms a mutual layer structure with a sensor (hereinafter referred to as a touch sensor) capable of sensing a touch input.

The optical sensor 120 may be used to form a 3D interface to receive a user input, and may include a light emitter and a light receiver. The light emitter may be an infrared (IR) light-emitting diode (LED), which emits IR waves. The light emitter may emit an optical signal. The optical signal may also refer to as a beam, a beam of light, or a light beam.

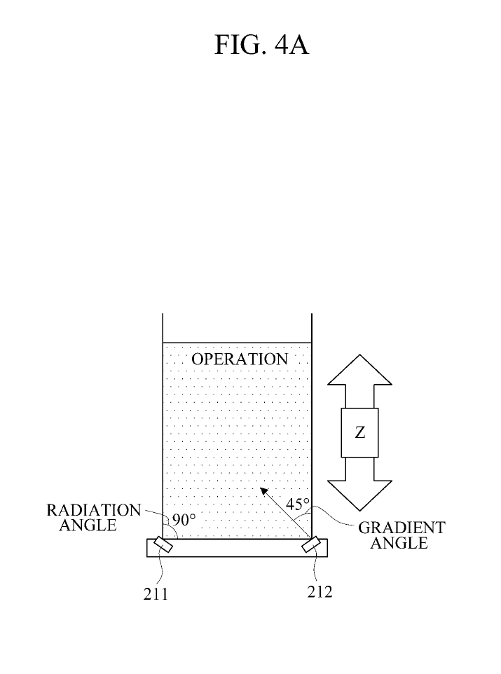

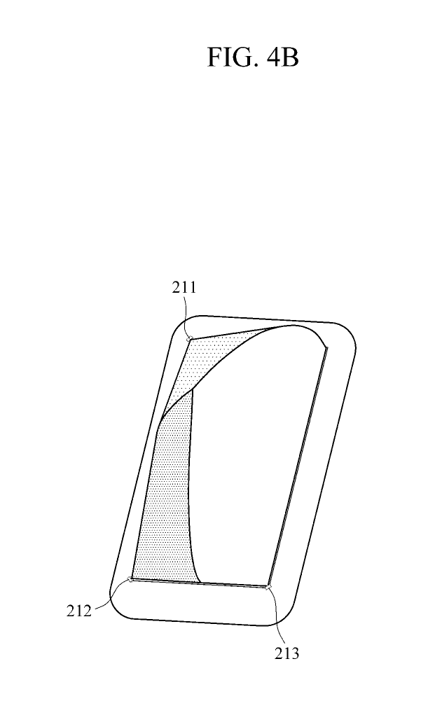

If the optical sensor 120 includes only one light emitter, the optical sensor 120 may recognize a location of an object one-dimensionally. If the optical sensor 120 includes two light emitters, the overlapping space of beams emitted by the two light emitters may be set as an input recognition space, thereby providing a two-dimensional (2D) or three-dimensional (3D) input recognition space. Meanwhile, a two- or higher-dimensional input recognition space may be generated based on the overlapping space of beams emitted by the two light emitters, the overlapping space may be formed at a location, for example, above the display unit 110 to form a large enough overlapping space to be used as the input recognition space. That is, the angle between the two beams emitted by the two light emitters may be appropriate to form the input recognition space. However, it may be difficult to form a proper input recognition space using two light emitters having a gradient of, for example, about 20 degrees, thus the user may have a difficulty in using the input recognition space. The gradient (“gradient angle”) may refer to an angle between the propagation direction of a beam emitted from a light emitter and z-axis as shown in FIG. 4A, or between the propagation direction of a beam emitted from a light emitter and a surface of a display (not shown). The installation angle of the two light emitters may be appropriately adjusted such that the input recognition space formed by the two light emitters is formed within reference proximity from the top of the display unit 110. Further, at least three light emitters may be used to form a 3D input recognition space.

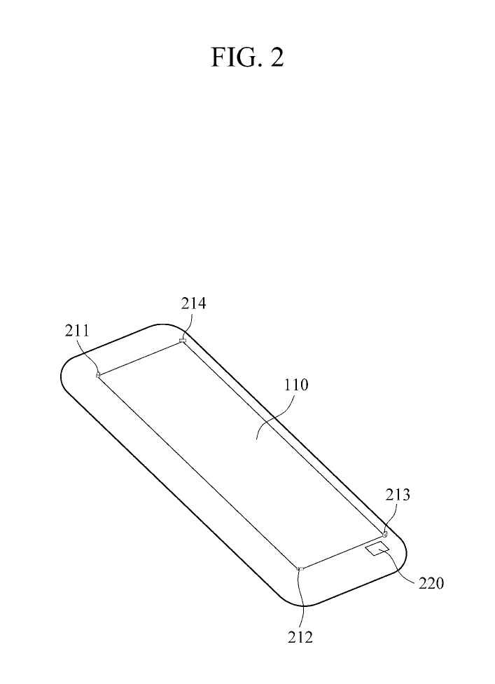

FIG. 2 is a diagram illustrating an optical sensor disposed in a mobile device according to an exemplary embodiment of the present invention.

Referring to FIG. 2, the optical sensor 120 may include multiple light emitters 211, 212, 213 and 214 and a light receiver 220. At least three light emitters, i.e., a first light emitter 211, a second light emitter 212, and a third light emitter 213, may be installed at the corners of the display unit 110, and the light receiver 220 may be installed on one side of the display unit 110. The light emitter 214 may be an auxiliary light emitter, which is optional. The light receiver 220 may be installed at one corner of the display unit 110 in place of the fourth light emitter; however, aspects are not limited thereto. If four light emitters 211, 212, 213, and 214 are installed on the display unit 110, as illustrated in FIG. 2, one of the four light emitters may be used as an auxiliary light emitter. The numbers and locations of the light emitters and light receivers in the optical sensor 120 are not limited to those illustrated in FIG. 2. Further, four light receivers may be installed at the four corners of the display unit 110 along with the four light emitters 211, 212, 213, and 214, or one or more light receivers may be installed on one or more areas of the display unit 110.

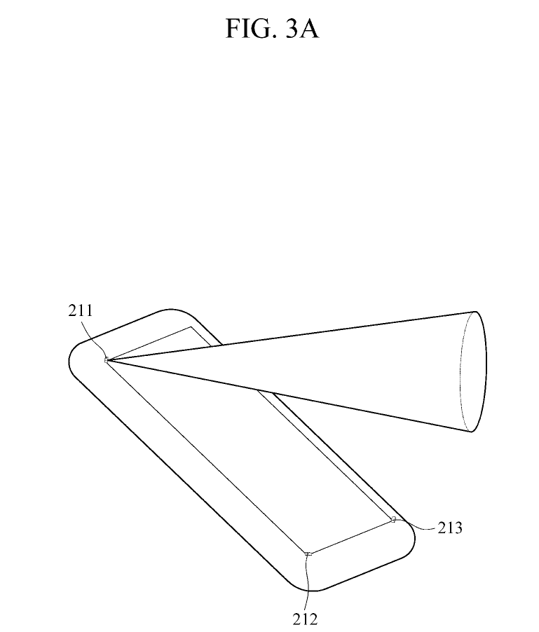

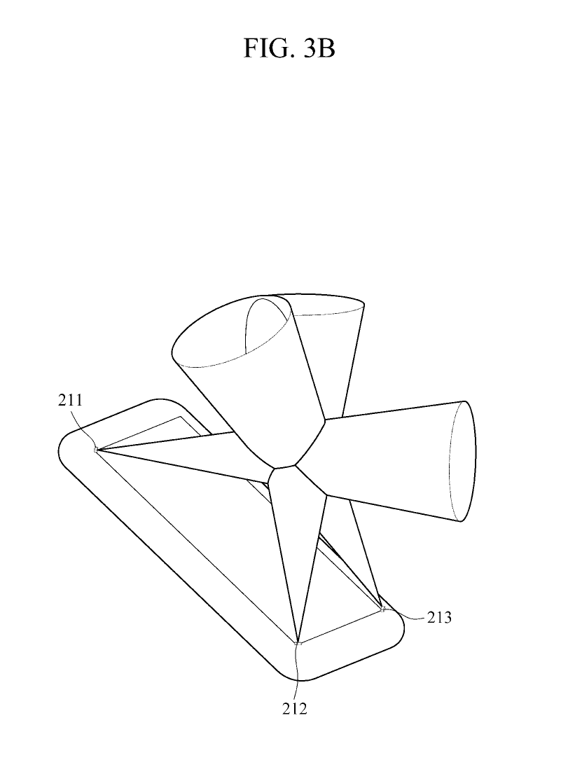

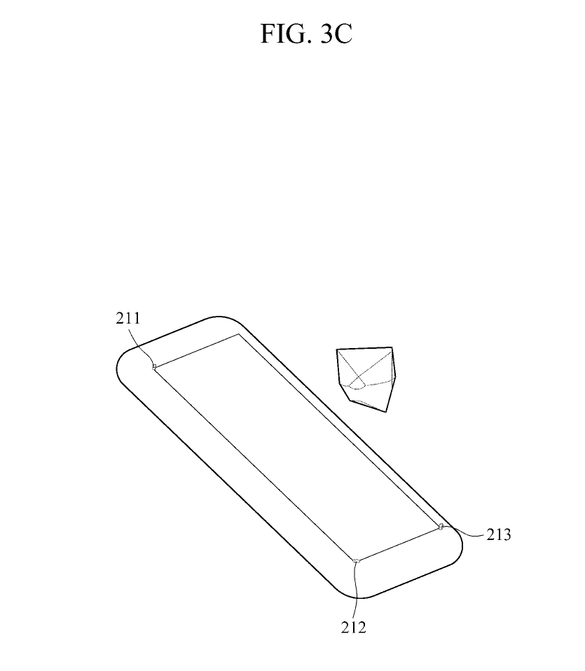

Optical signals emitted by the multiple light emitters 211, 212, 213, and 214 may form a 3D input recognition space, which will hereinafter be described in further detail with reference to FIG. 3A, FIG. 3B, and FIG. 3C.

FIG. 3A, FIG. 3B, and FIG. 3C are diagrams illustrating a formation of a 3D input recognition space according to an exemplary embodiment of the present invention.

Referring to FIG. 3A, the first light emitter 211 may emit an optical signal, in the form of a beam, in a determined direction at a determined angle with the surface of the display unit 110. Referring to FIG. 3B, each of the first, second, and third light emitters 211, 212, and 213 may emit the optical signal toward the center of the display unit 110 at the determined angle with the surface of the display unit 110.

The overlapping space of the beams emitted by the first, second, and third light emitters 211, 212, and 213 is illustrated in FIG. 3C. The overlapping space may be the 3D input recognition space or may be included the 3D input recognition space. For example, the 3D input recognition space may include a point of space where at least one beam emitted from at least one of the multiple light emitters 211, 212, 213, and 214 passes through. The 3D input recognition space may be expanded or reduced according to the radiation angle of the first emitter 211, the second emitter 212, the third light emitter 213, or the fourth light emitter 214 (such as IR LEDs).

FIG. 4A and FIG. 4B are diagrams illustrating a 3D input recognition space according to an exemplary embodiment of the present invention.

Referring to FIG. 4A, if the first and second light emitters 211 and 212 have a radiation angle of 90 degrees and the gradients of the first and second light emitters 211 and 212 are 45 degrees, a 3D input recognition space formed by the first and second light emitters 211 and 212 may be expanded in the direction of z-axis by an amount corresponding to the distance between the first and second light emitters 211 and 212. In this case, the 3D input recognition space may be expanded to cover the whole surface of the display unit 110 as shown in FIG. 4B.

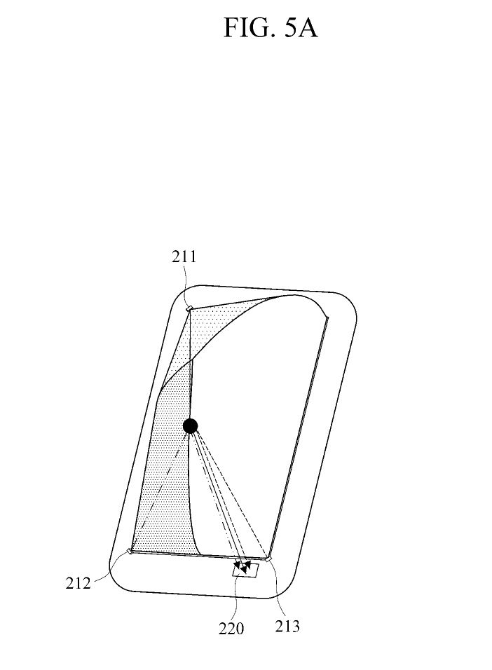

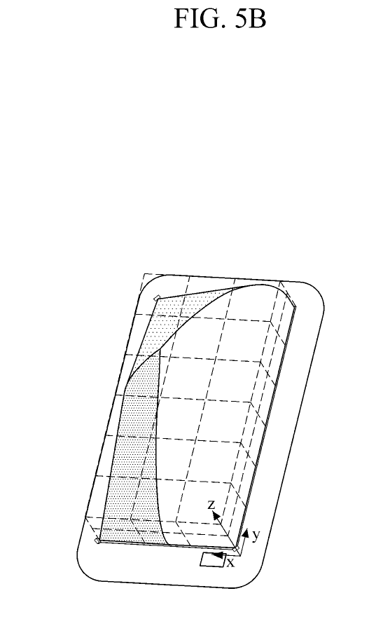

FIG. 5A and FIG. 5B are diagrams illustrating an acquisition of a coordinate of an object in a 3D input recognition space according to an exemplary embodiment of the present invention.

Referring to FIG. 5A, the light receiver 220 may receive optical signals emitted by the first, second, and third light emitters 211, 212, and 213 and reflected from an object. As shown in FIG. 5A, the light receiver 220 receives three types of optical signals reflected from an object. The reflected optical signals are emitted by the first, second, and third light emitters 211, 212, and 213 and reflected from the object. Optical signals emitted by the first, second, third, and fourth light emitters 211, 212, 213, and 214 may have different characteristics from one another, such as a wavelength, frequency, color, and the like, the light receiver 220 may distinguish received optical signals by recognizing the different characteristics. Thus, the light receiver 220 may distinguish the light emitters from which each of the optical signals is emitted. That is, the light receiver 220 may identify the color of an optical signal or measure the wavelength of the optical signals and may determine which of the first, second, third, and fourth light emitters 211, 212, 213, and 214 is the emitter of a received optical signal based on the characteristic of the received optical signal, such as color, frequency, and wavelength.

The quantity of light (or “luminous energy”) reflected from an object may vary according to a location of the object. Referring to FIG. 5B, each point within a 3D input recognition space may be represented by a set of coordinate values (x, y, z), and the quantity of light reflected from an object may vary according to a location of the object within the 3D input recognition space. For example, if an object is located at a point represented by (0, 0, 1), the luminous energy of each optical signal received by the light receiver 220 may be represented as (a, b, c) if the light receiver 200 receives three types of optical signals from the first, second, and third light emitters 211, 212, and 213. Luminous energy information, which includes luminous energy of each received optical signal, for every coordinate in the 3D input recognition space may be acquired by locating an object at every coordinate and measuring the luminous energy information for the coordinate. The location of an object in the 3D input recognition space may be extracted based on the luminance energy information.

Luminous energy information mapped to each coordinate (x, y, z) within the 3D input recognition space is referred to Table 1. The luminous energy information may be stored in the memory 130.

TABLE 1

| Coordinate | Light | Light | Light | Auxiliary |
|---|---|---|---|---|
| Values | Emitter 1 | Emitter 2 | Emitter 3 | Light Emitter |
| (0, 0, 1) | A | b | c | d |
| (0, 0, 2) | a | b | C | d |
| . . . | . . . | . . . | . . . | . . . |

Referring to Table 1, each coordinate (x, y, z) within the 3D input recognition space is mapped to a set of luminous energy values (Light emitter 1, Light emitter 2, Light emitter 3, Auxiliary light emitter), a set of luminous energy values emitted by Light Emitter 1, Light Emitter 2, Light Emitter 3, and Auxiliary Emitter, and the mapping results are stored the memory 130 as mapping information. The mapping information may be generated by the control unit 140. The mapping information may include mapping results between a set of luminous energy values and a coordinate located in the 3D input recognition space. The coordinate may be selected in the 3D input recognition space at a determined interval along the x-axis, y-axis, and z-axis.

Referring b to FIG. 2, the optical sensor 120 may transmit optical signal transmission information about the transmission of optical signals from each of the first, second, third, and fourth light emitters 211, 212, 213, 214 via the light receiver 220 to the control unit 140. The control unit 140 may detect a user input based on the optical signal transmission information provided by the optical sensor 120, such as whether the light receiver 220 has received optical signals, the quantity of light received by the light receiver 220 (luminous energy), or a variation in the quantity of light received by the receiver 220. That is, if the quantity of light transmitted from each of the first, second, and third light emitters 211, 212, and 213 to the light receiver 220 are represented by (a, b, c), the control unit 140 may extract a set of luminous energy values corresponding to the light amount information (a, b, c). Then, the control unit 140 may extract the coordinate value of an object mapped to the set of luminous energy values (a, b, c). The 3D input recognition space may have a regular and uniform shape two-dimensionally, i.e., on an x-y plane, but may not be formed as uniformly along the z-axis, it may cause confusion to a user about the boundaries of the 3D input recognition space if the 3D input recognition space is invisible to the user.

Thus, the boundaries of the 3D input recognition space may be defined by the following formulas: x<the horizontal length of the display unit 110; y<the vertical length of the display unit 110; and z<a determined height along the z axis.

In this manner, the 3D input recognition space may have uniform height along the z-axis, and thus a user may recognize the boundaries of the 3D input recognition space on the z axis.

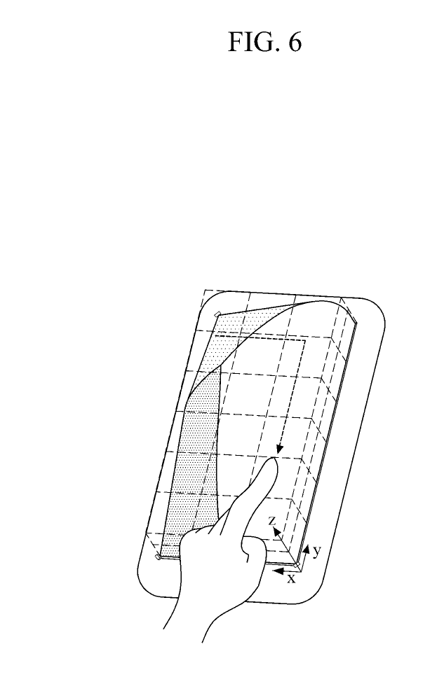

FIG. 6 is a diagram illustrating an operation of a 3D input interface according to an exemplary embodiment of the present invention.

Referring to FIG. 6, a user may provide a user input by moving an object three-dimensionally within the 3D input recognition space, i.e., the 3D input interface. Three-dimensional movement of the object may include movement of a finger of the user. An operation, such as turning pages of an e-book or navigating through lists of web, may be performed by a movement of a finger of the user in the air without touching the display unit 110. The 3D input interface may be used in various applications, such as games or web-surfing applications, which are operated by a three-dimensional input. The user may input a horizontal movement, a vertical movement, and a movement along the z-axis. The user may move a scrollbar or turn pages using the 3D input interface without touching the display unit 110. The user may provide various user inputs by making various motions including a movement along the z-axis for an operation, such as punching, pushing or pulling, in the 3D input recognition space using the 3D input interface as a control interface during an execution of an application, such as a game application.

An object having a volume, such as a finger, may not be able to be properly represented by a single set of coordinate values, and may be represented by multiple sets of coordinate values. If the object is used to manipulate the 3D input interface, the control unit 140 may extract the coordinate values of the center of the object based on all sets of coordinate values that are occupied by the object in response to the object entering the 3D input recognition space. Further, the multiple sets of coordinate values occupied by the object may be mapped to a set of luminance energy values and be stored in the memory 130.

The control unit 140 may output a signal to notify the user to recognize the boundaries of the 3D input recognition space. If an object enters into the 3D input recognition space by penetrating a boundary of the 3D input recognition space, the control unit 140 may indicate the entrance of the object by outputting a signal.

For example, the control unit 140 may display the location of the object or the entrance of the object into the 3D input recognition space on the display unit 110 by changing at least one of font, color, and brightness of an image displayed on the display unit 110. Further, an audio output unit (not shown) may be configured to output an audio signal or audible sounds in the apparatus, and the control unit 140 may control the audio output unit to output audio data indicating whether the object enters the 3D input recognition space. Further, the apparatus may include a vibration generation unit (not shown) configured to generate a vibration signal, and the control unit 140 may change the intensity of the vibration signal generated by the vibration generation unit if the object enters the 3D input recognition space. Further, the apparatus may include a light emission unit (such as a visible LED) configured to emit a visible light or visible waves, and the control unit 140 may change the color of the visible light or the visible waves emitted by the light emission unit if the object enters the 3D input recognition space. The visible light may be emitted by the display unit 110. In order to improve the recognition precision of a three-dimensional user input, four or more light emitters may be used, as illustrated in FIG. 2. By using three or more light emitters, the apparatus may be able to provide a stable input recognition space and improve the recognition precision of the user input. For example, if one or more of the light emitters are blocked by a hand, the auxiliary light emitter may enhance the recognition precision of a user input in the 3D input interface. As the number of light emitters for the 3D input interface increases, calculation errors of coordinate values may decrease, and additional software algorithms for calculating coordinate values may not be necessary.

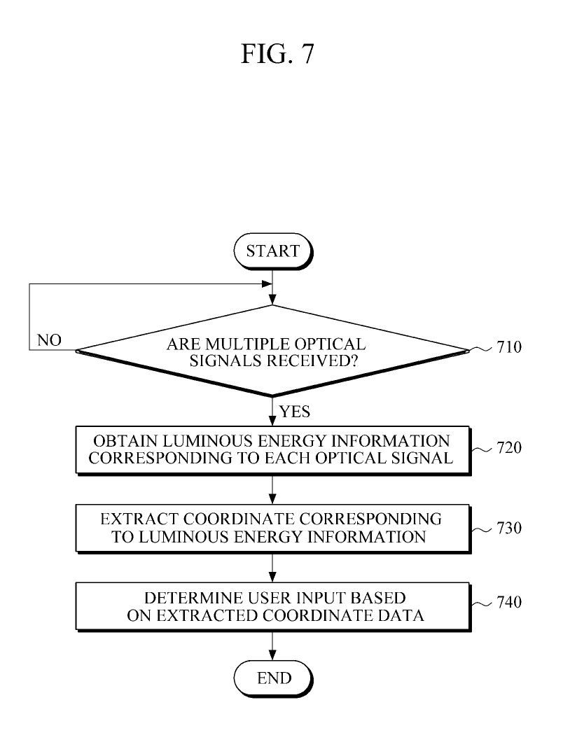

Hereinafter, a method for providing a 3D input interface will be described with reference to FIG. 7. The method may be described as performed by or with the apparatus shown in FIG. 1, but the method is not limited thereto.

FIG. 7 is a flowchart illustrating a method for providing a 3D input interface according to an exemplary embodiment of the present invention.

In the method, multiple optical signals may be emitted from multiple light emitters that are located at different locations at a determined angle to form a 3D overlapping space (not shown). Further, the quantity of light for each of the optical signal may be measured and corresponding luminous energy information may be obtained by a light receiver. Each of the optical signals is reflected from an object located in the 3D input interface. Then, the coordinate of the object may be extracted based on the luminous energy information.

Referring to FIG. 7, the control unit 140 determines whether multiple optical signals are received in operation 710.

The control unit 140 obtains luminous energy information corresponding to each of the optical signals in operation 720. The control unit 140 distinguishes each of the optical signals based on the wavelength or color of the optical signals, and identifies the incidence directions of the optical signals and the luminous energy values. The control unit 140 recognizes each of the light emitters based on the wavelength or color of the optical signals.

The control unit 140 may extract a coordinate corresponding to the luminous energy information in operation 730. That is, if the luminous energy information is (a, b, c), the control unit 140 extracts a coordinate data mapped to the luminous energy information from mapping data stored in memory 130. If two or more coordinates are extracted, a central coordinate of the two or more coordinates, i.e., an average or intermediate coordinate of the two or more coordinates, may be extracted.

The control unit 140 may determine a user input based on the extracted coordinate in operation 740, and perform an operation corresponding to the determined user input.

It may be possible to provide a 3D input interface in a mobile device, such as a mobile phone. The 3D input interface may enable the mobile device to eliminate additional heavy equipment for providing a user interface.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An apparatus to provide a three-dimensional (3D) input interface, the apparatus comprising:
multiple light emitters to each emit an optical signal having a determined characteristic to form a 3D input recognition space;
a light receiver to receive optical signal reflected from an object, which is located in the 3D input recognition space, and to obtain luminous energy information of the optical signal; and
a control unit to extract a coordinate of the object based on the luminous energy information, and to control an operation of the apparatus based on the coordinate of the object.

2. The apparatus of claim 1, wherein the determined characteristic comprises at least one of a wavelength or a color.

3. The apparatus of claim 1, further comprising:
a memory to store the luminous energy information and the mapping information,
wherein the control unit generates mapping information by mapping the luminous energy information to a coordinate in the 3D input recognition space, and retrieves the coordinate based on the mapping information.

4. The apparatus of claim 1, wherein the control unit calculates a central coordinate from more than one coordinate if the more than one coordinate is retrieved based on the mapping information.

5. The apparatus of claim 1, wherein the multiple light emitters comprise:
a first light emitter to emit a first optical signal having a first characteristic;
a second light emitter to emit a second optical signal having a second characteristic; and
a third light emitter to emit a third optical signal having a third characteristic,
wherein the first optical signal, the second optical signal and the third optical signal form a 3D overlapping space, the 3D overlapping space is comprised in the 3D input recognition space, and the light receiver receives the first optical signal, the second optical signal and the third optical signal that are reflected from the object.

6. The apparatus of claim 1, wherein the multiple light emitters further comprise an auxiliary light emitter to emit a fourth optical signal, and the control unit determines the coordinate of the object based on luminous energy information obtained from the fourth optical signal.

7. The apparatus of claim 1, wherein the control unit outputs a signal to indicate an entrance of the object into the 3D input recognition space on a display unit.

8. The apparatus of claim 1, further comprising:
an audio output unit to output an audio signal to indicate an entrance of the object into the 3D input recognition space.

9. The apparatus of claim 1, further comprising:
a vibration generation unit to generate a vibration signal to indicate an entrance of the object into the 3D input recognition space.

10. The apparatus of claim 1, further comprising:
a visible light emitter to emit a visible light to indicate an entrance of the object into the 3D input recognition space.

11. A method for providing a three-dimensional (3D) input interface, the method comprising:
emitting multiple optical signals from different locations at a determined angle with respect to a surface of a display unit to generate a 3D input recognition space on the display unit;
receiving optical signals reflected from an object located in the 3D input recognition space;
obtaining luminous energy information from each of the optical signals reflected from the object; and
extracting a coordinate of the object in the 3D input recognition space based on the luminous energy information.

12. The method of claim 11, wherein the multiple optical signals have different wavelengths or colors.

13. The method of claim 11, further comprising:
storing mapping information comprising multiple coordinates and corresponding luminous energy information,
wherein the extracting of the coordinate comprises searching the coordinate of the object mapped to the luminous energy information based on the mapping information.

14. The method of claim 11, wherein extracting of the coordinate comprises calculating a central coordinate of multiple coordinates if the multiple coordinates are extracted based on the luminous energy information.

15. The method of claim 11, wherein the optical signals comprise at least three optical signals having different characteristics.

16. The method of claim 11, further comprising:
determining whether the object penetrates a boundary of the 3D input recognition space; and
outputting a signal if it is determined that the object penetrates the boundary of the 3D input recognition space.

17. The method of claim 15, further comprising:
emitting an optical signal from an auxiliary light emitter based on the luminous energy value of the at least three optical signals.

18. The method of claim 11, further comprising:
generating the 3D input recognition space to have a uniform height in a direction perpendicular to the display unit.
